(19) United States
(12) Patent Application Publication
(10) Pub. No.: US 2025/0391861 A1
(43) Pub. Date: Dec. 25, 2025

(54) SCALE-UP FORMULATIONS FOR AQUEOUS GRAPHITE ANODE AND METHOD

(71) Applicant: GM Global Technology Operations LLC, Detroit, MI (US)

(72) Inventors: Bradley R. Frieberg, Farmington Hills, MI (US); Roland J. Koestner, Plymouth, MA (US); Xiaosong Huang, Novi, MI (US); Taylor Syring, Sterling Heights, MI (US); Kan Huang, Sterling Heights, MI (US); Hui He, Oakland Charter Township, MI (US)

(21) Appl. No.: 18/749,827

(22) Filed: Jun. 21, 2024

(51) Int. Cl. H01M 4/583; H01M 4/02; H01M 4/04; H01M 4/1393; H01M 4/62

(52) U.S. Cl. CPC H01M 4/583; H01M 4/0404; H01M 4/1393; H01M 4/622; H01M 4/625; H01M 2004/027

(57) ABSTRACT

An anode electrode is provided. The anode electrode includes an anode current collector and an anode active material layer disposed on the anode current collector. The anode active material layer includes an electrochemically active material, a dispersant polymer binder, an adhesive polymer binder, and a conductive filler. The electrochemically active material includes graphite. The dispersant polymer binder has amphiphilic properties including a hydrophobic domain and a hydrophilic domain that stabilizes hydrophobic carbons in water. The adhesive polymer binder has a glass transition temperature that provides flexibility, durability, and cohesive strength between carbon particles. The conductive filler includes a conductive carbon that reduces pore channel and charge transfer resistance at a binder active material interface.

### INTRODUCTION

The present disclosure relates to battery cells, and more particularly, to anode electrodes including formed using an aqueous anode slurry.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

Battery cells include anode electrodes, cathode electrodes, and separators arranged in a predetermined sequence in an enclosure. The anode electrodes include an anode current collector and an anode active material layer arranged on one or both sides of the anode current collector. The anode active material layer is often applied onto the anode current collector as a slurry. However, sometimes the anode active layer materials do not mix well, and the slurry may not adhere to the anode current collector satisfactorily.

While prior art methods and systems attempt to provide an anode electrode with satisfactory electrochemical performance and may achieve their particular purpose, a need still exists for a new and improved anode electrode. Accordingly, a more efficient and better-quality anode electrode is needed.

### SUMMARY

According to several aspects of the present disclosure, an anode electrode is provided. The anode electrode includes an anode current collector and an anode active material layer disposed on the anode current collector. The anode active material layer includes an electrochemically active material, a dispersant polymer binder, an adhesive polymer binder, and a conductive filler. The electrochemically active material includes graphite. The dispersant polymer binder has amphiphilic properties including a hydrophobic domain and a hydrophilic domain that stabilizes hydrophobic carbons in water. The adhesive polymer binder has a glass transition temperature that provides flexibility, durability, and cohesive strength between carbon particles. The conductive filler includes a conductive carbon that reduces pore channel and charge transfer resistance at a binder active material interface.

In accordance with another aspect of the disclosure, the anode electrode has graphite includes at least one of natural graphite or artificial graphite.

In accordance with another aspect of the disclosure, the anode electrode has an electrochemically active material including less than 10 wt. %, at least one of silicon (Si), silicon oxide (SiO), lithium silicon oxide (LiSiO), silicon oxide composite (SiO-c), nanostructured silicon (nano-Si), or nanocaged Si.

In accordance with another aspect of the disclosure, the anode electrode has an electrochemically active material between 94 wt. % to 97 wt. % of the anode electrode.

In accordance with another aspect of the disclosure, the anode electrode has a dispersant polymer binder including at least one of sodiated or lithiated carboxymethyl cellulose (CMC).

In accordance with another aspect of the disclosure, the sodiated or lithiated carboxymethyl cellulose (CMC) has a degree of substitution (DS) less than 0.8.

In accordance with another aspect of the disclosure, the sodiated or lithiated carboxymethyl cellulose (CMC) has a molecular weight greater than 300 kilodaltons (kDa).

In accordance with another aspect of the disclosure, the sodiated or lithiated carboxymethyl cellulose (CMC) includes a blend of at least a first CMC with a degree of substitution (DS) of 0.7 and a second CMC with a DS of 1.2.

In accordance with another aspect of the disclosure, the dispersant polymer binder includes sodiated or lithiated polyacrylic acid.

In accordance with another aspect of the disclosure, the sodiated or lithiated carboxymethyl cellulose (CMC) is between 0.6 wt. % and 2.5 wt. % of the anode electrode.

In accordance with another aspect of the disclosure, the anode electrode has an adhesive polymer binder including at least one of styrene butadiene rubber (SBR), styrene acrylic rubber, nitrile butadiene rubber, or copolymers thereof.

In accordance with another aspect of the disclosure, the anode electrode includes an adhesive polymer binder having a glass transition temperature less than 20° C.

In accordance with another aspect of the disclosure, the anode electrode includes an adhesive polymer binder between 1.5 wt. % and 3.0 wt. % of the anode electrode.

In accordance with another aspect of the disclosure, the anode electrode has a conductive filler including at least one of carbon black, acetylene black, ketjen black, carbon nanofibers, graphene, graphene nanoplatelets, carbon nanotubes, or combinations thereof.

In accordance with another aspect of the disclosure, the anode electrode has a conductive filler between 0.3 wt. % and 1.2 wt. % of the anode electrode.

According to several aspects of the present disclosure, an anode electrode is provided. The anode electrode includes an anode current collector and an anode active material layer. The anode active material layer includes an electrochemically active material including graphite, a dispersant polymer binder, an adhesive polymer binder, and a conductive filler. The dispersant polymer binder has amphiphilic properties including a hydrophobic domain and a hydrophilic domain that stabilizes hydrophobic carbons in water. The dispersant polymer includes a first carboxymethyl cellulose (CMC) with a degree of substitution (DS) of 0.7 and a second CMC with a DS of 1.2. The adhesive polymer binder has a glass transition temperature that provides flexibility, durability, and cohesive strength between carbon particles. The conductive filler includes a conductive carbon that reduces pore channel and charge transfer resistance at a binder active material interface. The conductive filler is between 0.3 wt. % and 1.2 wt. % of the anode electrode.

In accordance with another aspect of the disclosure, the anode electrode has an electrochemically active material including at least one of natural graphite or artificial graphite.

In accordance with another aspect of the disclosure, the anode electrode has an adhesive polymer binder including at least one of styrene butadiene rubber (SBR), styrene acrylic rubber, nitrile butadiene rubber, or copolymers thereof.

In accordance with another aspect of the disclosure, the anode electrode has an electrochemically active material between 94 wt. % and 96 wt. % of the anode electrode, a dispersant polymer binder between 1.4 wt. % and 2.0 wt. % of the anode electrode, an adhesive polymer binder between 2.2 wt. % and 3.0 wt. % of the anode electrode, and a conductive filler between 0.4 wt. % and 1.0 wt. % of the anode electrode.

According to several aspects of the present disclosure, a method for forming an aqueous graphite anode is provided. The method includes preparing a slurry for coating an anode current collector with an anode active material layer and coating the anode current collector with the slurry to form the anode active material layer disposed on the aqueous graphite anode. The anode active material layer includes an electrochemically active material including graphite, a dispersant polymer binder, an adhesive polymer binder, and a conductive filler. The dispersant polymer binder has amphiphilic properties including a hydrophobic domain and a hydrophilic domain that stabilizes hydrophobic carbons in water. The dispersant polymer includes a first carboxymethyl cellulose (CMC) with a degree of substitution (DS) of 0.7 and a second CMC with a DS of 1.2. The adhesive polymer binder has a glass transition temperature that provides flexibility, durability, and cohesive strength between carbon particles. The conductive filler includes a conductive carbon that reduces pore channel and charge transfer resistance at a binder active material interface. The conductive filler is between 0.3 wt. % and 1.2 wt. % of the anode active material layer.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle including a battery pack having a plurality of battery cells, in accordance with the present disclosure.

FIG. 2 is a perspective view illustrating a battery cell disposed within the battery pack shown in FIG. 1, where the battery cell includes at least one electrode stack having an anode layer using the anode active material disclosed herein, in accordance with the present disclosure.

FIG. 3 is a graphical depiction illustrating a model carbon dispersion for different dispersant polymer binders used in the anode active material disclosed herein, in accordance with the present disclosure.

FIG. 4 is a graphical depiction illustrating a slurry processibility for different dispersant polymer binders with a degree of substitution of 0.7 used in the anode active material disclosed herein, in accordance with the present disclosure.

FIG. 5 is a graphical depiction illustrating a peel strength for different adhesive polymer concentrations used in the anode active material disclosed herein, in accordance with the present disclosure.

FIG. 6 is a graphical depiction illustrating ionic resistance and tortuosity for different conductive filler concentrations used in the anode active material disclosed herein, in accordance with the present disclosure.

FIG. 7 is a graphical depiction illustrating ionic resistance and tortuosity for different conductive filler surface areas used in the anode active material disclosed herein, in accordance with the present disclosure.

FIG. 8 is a flowchart illustrating a method for forming the aqueous graphite anode as shown in FIG. 2, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

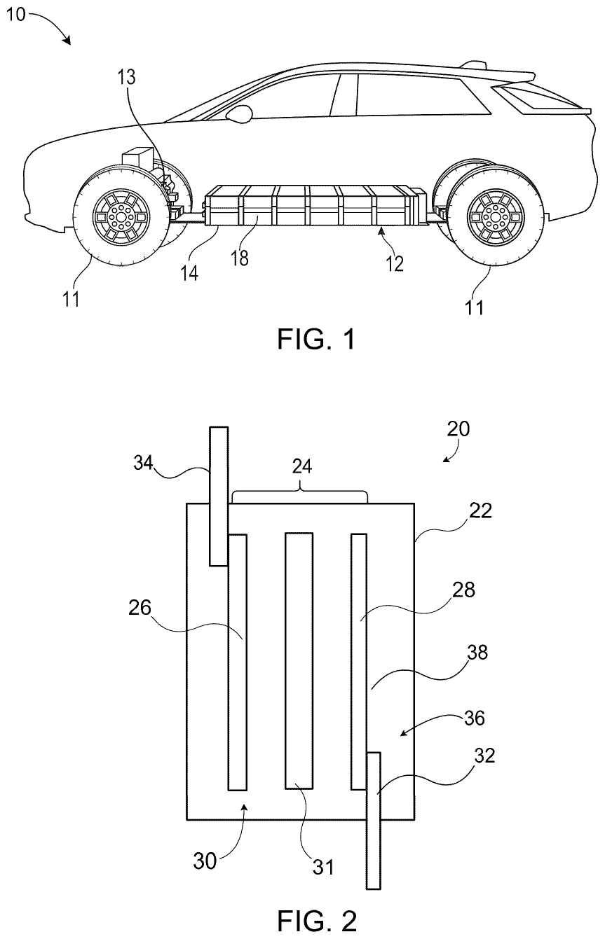

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. In an example, the battery pack 12 may have fifty or more battery cells 18.

Referring now to FIG. 2, a perspective view illustrates a battery cell 18 disposed within the battery pack 12 shown in FIG. 1, in accordance with an aspect of the present disclosure. Each battery cell 18 has a housing 22 or case, and at least one electrode stack 24, which includes a cathode 26, an anode 28, an electrolyte 30, and a separator 31. In some instances, the electrolyte 30 may include a solid electrolyte that replaces a liquid electrolyte and separator. Each battery cell 18 may have tens or hundreds of electrode stacks 24. Each electrode stack 24 is connected to a current collector 32, 34. The electrode stacks are placed in the housing 22 and the housing 22 is filled with a suitable electrolyte 30. Current collectors 32, 34 are thin metal plates or foils disposed, for example, on either side of the electrode stacks 24 and/or housing 22 and typically have a thickness between 0.4 and 1 millimeter. The current collectors 32, 34 may be made of copper or aluminum. The current collectors 32, 34 are attached to the electrode stacks 24 to transmit the electric current to an external circuit (not shown).

Still referring to FIG. 2, the anode electrode 36 includes an anode current collector 32 and an anode active material layer 38. The anode active material layer 38 includes a combination of active material(s), binder(s), and conductive filler(s) that optimize the processibility and mechanical and electrochemical properties of the anode electrodes.

The anode active material includes electrochemically active materials, for example graphite. The graphite may include a variety of geometries, for example platelet-like, rounded or spherical, and combinations thereof. Additionally, the anode active material may include less than 10 wt. % of silicon (Si), lithium silicon oxide (LiSiOₓ), silicon oxide (SiOₓ), lithium silicon oxide and graphite, silicon oxide and graphite, silicon oxide composite (SiO-c), nanostructured silicon (nano-Si), nanocaged Si, and/or combinations thereof. The anode active material may include graphite, which may further include natural graphite and/or artificial graphite. Moreover, the electrochemically anode active material can be between about 94 wt. % to 97 wt. % (e.g., 94 wt. % to 96 wt. %) of the anode electrode. In this context, the term “about” is known to those skilled in the art. Alternatively, the term “about” may be read to mean plus or minus 0.1% by weight.

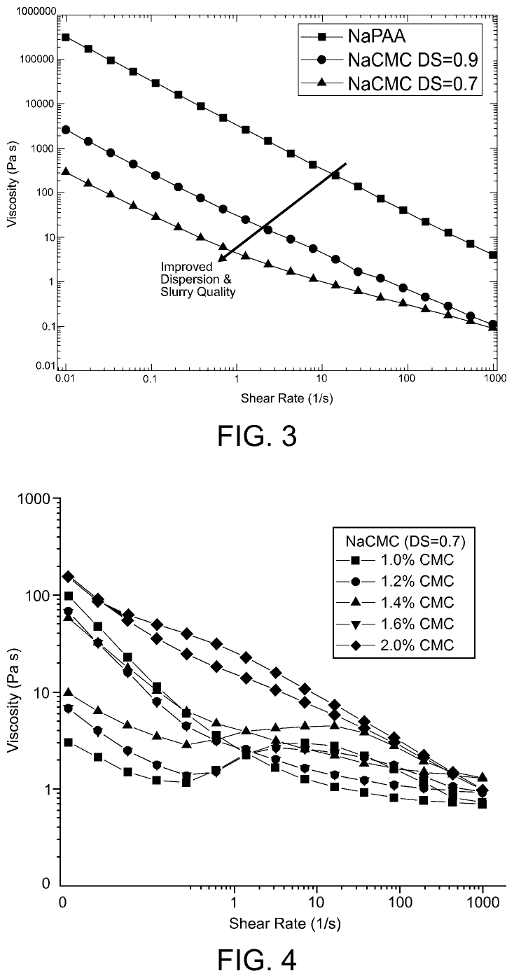

The anode active material includes a dispersant polymer binder. The dispersant polymer binder has amphiphilic properties including a hydrophobic domain and a hydrophilic domain that stabilizes hydrophobic carbons in water. The dispersant polymer binder may include at least one of sodiated (NaCMC) or lithiated (CMC-Li) carboxymethyl cellulose (CMC). The dispersant polymer binder can have a low degree of substitution (DS). As illustrated in the model carbon dispersion shown in FIG. 3, a polymer having a lower DS improves dispersion of graphite in water and improves electrochemical performance. For example, the NaCMC with a DS of 0.7 shown in FIG. 3 has an improved dispersion and slurry quality because of the lower viscosity in Pascal seconds (Pa—s) for a higher shear rate (1/second). In an example, the dispersant polymer binder has a degree of substitution less than 0.8, and more preferably a degree of substitution including and between 0.6 and 0.8.

The anode active material includes the dispersant polymer binder to provide sufficient adsorption coverage, which imparts electrosteric stability of a resulting anode slurry. A smooth, homogenous slurry leads to a four-fold increase in peel strength and increased flexibility of the resulting anode active material on the anode current collector 32. In general, the dispersant polymer binder is between 0.6 wt. % and 2.5 wt. % of the anode active material depending on the specific graphite used. As illustrated in the graphical depiction in FIG. 4, using NaCMC having a DS of 0.7 at about 2.0 wt. % provides a more stable anode active material while in slurry form. The s-shaped curves shown in FIG. 4 indicate agglomeration or the presence of chunks, which is undesirable. For example, the dispersant polymer binder may be between about 1.5 wt. % to 2.5 wt. % of the anode active material when artificial graphite or platelet-like graphite is used. When natural graphite or round graphite is used, the dispersant polymer binder may be between about 0.6 wt. % and 1.4 wt. % of the anode active material. In one example, the anode active material includes a dispersant polymer binder of 2.0 wt. % NaCMC having a degree of substitution of 0.7. In this context, the term “about” is known to those skilled in the art. Alternatively, the term “about” may be read to mean plus or minus 0.1% by weight.

Moreover, the dispersant polymer binder may have a high molecular weight to improve cohesion strength between particles. For example, the dispersant polymer binder may have a molecular weight greater than 300 kilodaltons (kDa).

The dispersant polymer binder may include a blend of multiple polymers each with different characteristics to delay or prevent gelation of the dispersant polymer binder during a drying process. For example, the dispersant polymer binder may include a first polymer having a degree of substitution of 0.7 and a second polymer having a degree of substitution of 1.2. In another example, the dispersant polymer binder may include a first polymer having a molecular weight of about 300 kDa and a second polymer having a molecular weight of about 400 kDa. In this context, the term “about” is known to those skilled in the art. Alternatively, the term “about” may be read to mean plus or minus 10 kDa.

The dispersant polymer binder may include polyacrylic acid, which is ionically conductive. For example, the polyacrylic acid may include a lithiated polyacrylic acid, which is slightly neutralized, or a sodiated polyacrylic acid.

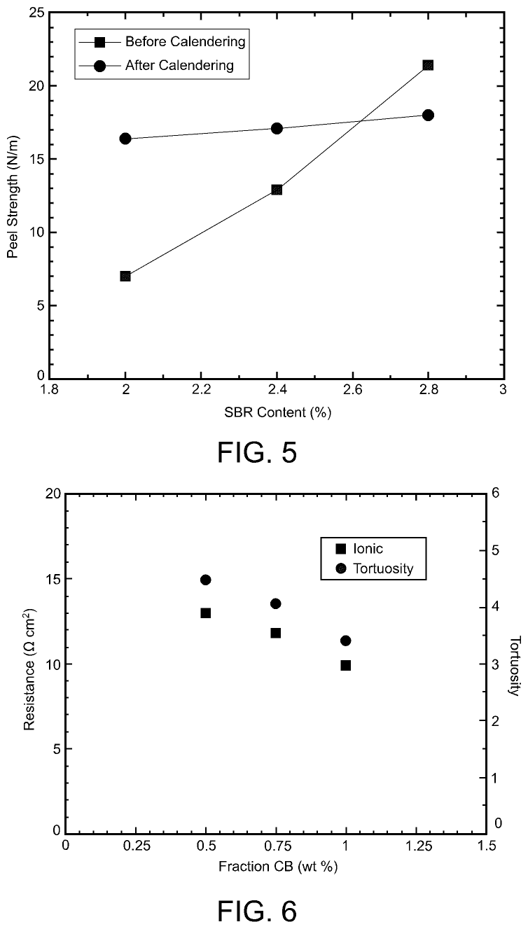

The anode active material includes an adhesive polymer binder with a low glass transition temperature to provide flexibility, durability, a cohesive strength between particles and adhesive strength to the current collector. The adhesive polymer binder may typically be used as a partially crosslinked particle stabilized by a surfactant in water. In an example, the adhesive polymer binder includes styrene butadiene rubber (SBR), styrene acrylic rubber, nitrile butadiene rubber, or combinations thereof. The adhesive polymer binder has a low glass transition temperature, for example less than 20° C. The adhesive polymer binder can include and be between about 1.5 wt. % and 3.0 wt. % (e.g., 2.2 wt. % and 3.0 wt. %) of the anode active material. As shown by the graphical depiction in FIG. 5, increasing SBR content in the range of 2.0 wt. % to 2.8 wt. % improves durability of the anode active material coating on the anode current collector 32 as indicated by an increased peel strength in Newtons per meter (N/m). In this context, the term “about” is known to those skilled in the art. Alternatively, the term “about” may be read to mean plus or minus 0.1% by weight.

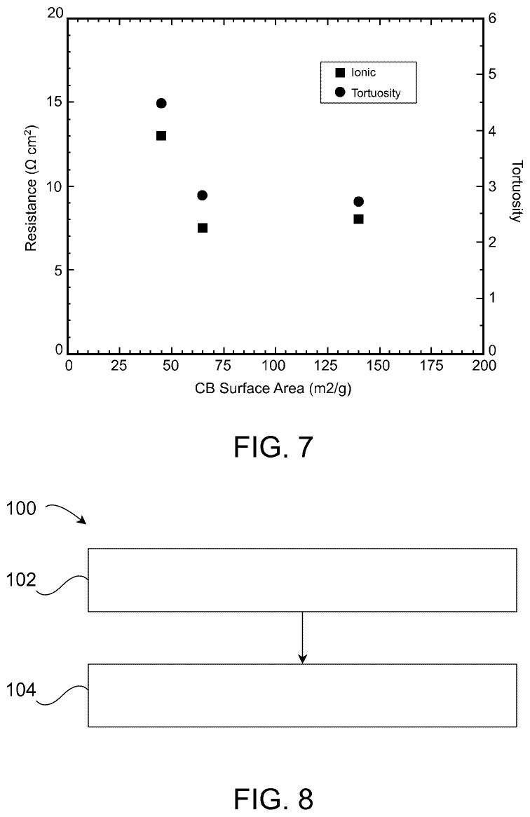

The anode active material includes a conductive filler or a conductive carbon additive combined with the anode active material, the dispersant polymer, and the adhesive polymer. The conductive filler, or conductive carbon, reduces both pore channel and charge transfer resistance at the binder active material interface. FIG. 6 illustrates that an increased fraction of carbon black (wt. %) results in decreased ionic resistance in ohms centimeters squared (Ωcm²). FIG. 7 illustrates that anode active material formulations increasing carbon content (e.g., 65 m²/g and 140 m²/g) shown an improved ionic resistance relative to carbon with less surface area (45 m²/g). The conductive filler can include one or more of carbon black (CB), acetylene black, ketjen black, carbon nanofibers, graphene, graphene nanoplatelets, carbon nanotubes, multi-wall carbon nanotubes, single-wall nanotubes, and/or combinations thereof. In an example, the conductive filler may include and be between about 0.3 wt. % and about 1.2 wt. % (e.g., 0.4 wt. % and 1.0 wt. %) of the anode electrode. In another example, the conductive filler may be between about 0.5 wt. % and about 1.0 wt. % of the anode electrode. In this context, the term “about” is known to those skilled in the art. Alternatively, the term “about” may be read to mean plus or minus 0.1% by weight.

With reference to FIG. 8, a method 100 for forming an anode electrode is presented, in accordance with the present disclosure. The method starts at block 102.

Block 102 depicts preparing a slurry for coating an anode current collector with an anode active material layer. The anode active material layer includes the electrochemically active material including graphite, the dispersant polymer binder, the adhesive polymer binder, and the conductive filler. The dispersant polymer binder has amphiphilic properties including a hydrophobic domain and a hydrophilic domain that stabilizes hydrophobic carbons in water. The dispersant polymer binder includes a first carboxymethyl cellulose (CMC) with a degree of substitution (DS) of 0.7 and a second CMC with a DS of 1.2. The conductive filler includes a conductive carbon that reduces pore channel and charge transfer resistance at a binder active material interface. The conductive filler is between 0.3 wt. % and 1.2 wt. % of the anode electrode. Preparing the slurry can include combining the anode active material, the dispersant polymer binder, the adhesive binder, and the conductive filler with water, for example in a tank with a mixer, such as a helical mixer. Carbon and carbon coated particles, for example the graphite of the anode active material, is generally hydrophobic and prefers to agglomerate in water-based solutions than stay as discrete particles and has poor cohesion strength, which causes cracking and flaking when applied to an anode current collector. However, the resulting slurry, because of the combination of anode active material components disclosed herein, maximizes processability, slurry quality, dispersion quality, and mechanical integrity of the anode electrode providing satisfactory electrochemical performance. The method then moves to block 104.

Block 104 depicts coating the anode current collector with the slurry to form the anode active material layer disposed on the aqueous graphite anode. Coating the anode current collector may include spreading or casting the slurry on a surface of the anode current collector, for example, by using a doctor blade, a slot die coater, or other suitable deposition technique.

The anode electrode and method of the present disclosure is advantageous and beneficial over the prior art. The anode active material used in the anode electrode disclosed herein provides a water-based formulation for a robust, high-quality graphite-based electrode. The combination of materials allows for improved slurry and electrode quality, mechanical durability, reduced electrode internal resistance with high electrochemical performance. The formulation described herein provides for anode active material slurry stability with an absence of agglomeration or chunks therein and an absence of flacking or cracking when the anode active material slurry is coated onto the current collector. The dispersant polymer binder used in the formulation with a lower degree of separation improves the dispersion of graphite in water and improves electrochemical performance. Using the concentration of dispersant polymer binder provides sufficient adsorption coverage, which imparts electrosteric stability of the resulting anode active material slurry. Additionally, the resulting smooth and homogenous slurry leads to an increase in peel strength and increased flexibility of the anode active material layer. Moreover, the adhesive polymer binder provides coating durability, and the conductive filler improves pore channel tortuosity and a reduced ionic resistance.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An anode electrode, comprising:
an anode current collector; and
an anode active material layer disposed on the anode current collector, the anode active material layer including:
an electrochemically active material including graphite;
a dispersant polymer binder having amphiphilic properties including a hydrophobic domain and a hydrophilic domain that stabilizes hydrophobic carbons in water;
an adhesive polymer binder having a glass transition temperature that provides flexibility, durability, and cohesive strength between carbon particles; and
a conductive filler including a conductive carbon that reduces pore channel and charge transfer resistance at a binder active material interface.

2. The anode electrode of claim 1, wherein the graphite includes at least one of natural graphite or artificial graphite.

3. The anode electrode of claim 1, wherein the electrochemically active material includes less than 10 wt. %, at least one of silicon (Si), silicon oxide (SiO), lithium silicon oxide (LiSiO), silicon oxide composite (SiO-c), nanostructured silicon (nano-Si), or nanocaged Si.

4. The anode electrode of claim 1, wherein the electrochemically active material is between 94 wt. % to 97 wt. % of the anode electrode.

5. The anode electrode of claim 1, wherein the dispersant polymer binder includes at least one of sodiated or lithiated carboxymethyl cellulose (CMC).

6. The anode electrode of claim 5, wherein the sodiated or lithiated carboxymethyl cellulose (CMC) has a degree of substitution (DS) less than 0.8.

7. The anode electrode of claim 5, wherein the sodiated or lithiated carboxymethyl cellulose (CMC) has a molecular weight greater than 300 kilodaltons (kDa).

8. The anode electrode of claim 5, wherein the sodiated or lithiated carboxymethyl cellulose (CMC) includes a blend of at least a first CMC with a degree of substitution (DS) of 0.7 and a second CMC with a DS of 1.2.

9. The anode electrode of claim 5, wherein the dispersant polymer binder includes sodiated or lithiated polyacrylic acid.

10. The anode electrode of claim 5, wherein the sodiated or lithiated carboxymethyl cellulose (CMC) is between 0.6 wt. % and 2.5 wt. % of the anode electrode.

11. The anode electrode of claim 1, wherein the adhesive polymer binder includes at least one of styrene butadiene rubber (SBR), styrene acrylic rubber, nitrile butadiene rubber, or copolymers thereof.

12. The anode electrode of claim 1, wherein the adhesive polymer binder has a glass transition temperature less than 20° C.

13. The anode electrode of claim 1, wherein the adhesive polymer binder is between 1.5 wt. % and 3.0 wt. % of the anode electrode.

14. The anode electrode of claim 1, wherein the conductive filler includes at least one of carbon black, acetylene black, ketjen black, carbon nanofibers, graphene, graphene nanoplatelets, carbon nanotubes, or combinations thereof.

15. The anode electrode of claim 1, wherein the conductive filler is between 0.3 wt. % and 1.2 wt. % of the anode electrode.

16. An anode electrode, comprising:
an anode current collector; and
an anode active material layer including:
an electrochemically active material including graphite;
a dispersant polymer binder having amphiphilic properties including a hydrophobic domain and a hydrophilic domain that stabilizes hydrophobic carbons in water, wherein the dispersant polymer includes a first carboxymethyl cellulose (CMC) with a degree of substitution (DS) of 0.7 and a second CMC with a DS of 1.2;
an adhesive polymer binder having a glass transition temperature that provides flexibility, durability, and cohesive strength between carbon particles; and
a conductive filler including a conductive carbon that reduces pore channel and charge transfer resistance at a binder active material interface, wherein the conductive filler is between 0.3 wt. % and 1.2 wt. % of the anode electrode.

17. The anode electrode of claim 16, wherein the graphite includes at least one of natural graphite or artificial graphite.

18. The anode electrode of claim 16, wherein the adhesive polymer binder includes at least one of styrene butadiene rubber (SBR), styrene acrylic rubber, nitrile butadiene rubber, or copolymers thereof.

19. The anode electrode of claim 16, wherein the electrochemically active material is between 94 wt. % and 96 wt. % of the anode electrode, the dispersant polymer binder is between 1.4 wt. % and 2.0 wt. % of the anode electrode, the adhesive polymer binder is between 2.2 wt. % and 3.0 wt. % of the anode electrode, and the conductive filler is between 0.4 wt. % and 1.0 wt. % of the anode electrode.

20. A method for forming an aqueous graphite anode, comprising:
preparing a slurry for coating an anode current collector with an anode active material layer, wherein the anode active material layer includes:
an electrochemically active material including graphite;
a dispersant polymer binder having amphiphilic properties including a hydrophobic domain and a hydrophilic domain that stabilizes hydrophobic carbons in water, wherein the dispersant polymer includes a first carboxymethyl cellulose (CMC) with a degree of substitution (DS) of 0.7 and a second CMC with a DS of 1.2;
an adhesive polymer binder having a glass transition temperature that provides flexibility, durability, and cohesive strength between carbon particles; and
a conductive filler including a conductive carbon that reduces pore channel and charge transfer resistance at a binder active material interface, wherein the conductive filler is between 0.3 wt. % and 1.2 wt. % of the anode active material layer; and
coating the anode current collector with the slurry to form the anode active material layer disposed on the aqueous graphite anode.
